(19) United States
(12) Patent Application Publication
(10) Pub. No.: US 2025/0278658 A1
(43) Pub. Date: Sep. 4, 2025

(54) MAJORANA Parity Readout Tuning Protocol

(71) Applicant: Microsoft Technology Licensing, LLC, Redmond, WA (US)

(72) Inventors: Roman Bela BAUER, Santa Barbara, CA (US); Samuel BOUTIN, Goleta, CA (US); Cassandra Joyce CHUA, Randwick (AU); Torsten KARZIG, Goleta, CA (US); Jonne Verneri KOSKI, The Hague (NL); Thorvald Wadum LARSEN, Seattle, WA (US); Roman Mykolayovych LUTCHYN, Santa Barbara, CA (US); Luca PETIT, Delft (NL); John David WATSON, Delft (NL)

(73) Assignee: Microsoft Technology Licensing, LLC, Redmond, WA (US)

(21) Appl. No.: 18/657,652

(22) Filed: May 7, 2024

Related U.S. Application Data
(60) Provisional application No. 63/621,547, filed on Jan. 16, 2024.

(51) Int. Cl. G06N 10/60; G06N 10/40

(52) U.S. Cl. CPC G06N 10/60; G06N 10/40

(57) ABSTRACT

Examples are disclosed that relate to tuning a topological qubit device. One example provides, on a quantum computing device, a method of tuning a topological qubit device into a Majorana Parity Readout (MPR) configuration. The method comprises performing optimization of an MPR signal by iteratively adjusting one or more tuning parameters of a plurality of tuning parameters, the plurality of tuning parameters comprising a quantum dot (QD) detuning, an enclosed flux, a voltage of a topological wire, a QD-Majorana zero mode (MZM) coupling, and a QD-QD coupling. Performing optimization of the MPR signal further comprises iteratively measuring the MPR signal using a readout resonator. Optimization of the MPR signal is iteratively performed until reaching a success metric.

### CROSS REFERENCE TO RELATED APPLICATIONS

This application claims priority to U.S. Provisional Patent Application Ser. No. 63/621,547, filed Jan. 16, 2024, the entirety of which is hereby incorporated herein by reference for all purposes.

### BACKGROUND

A quantum computer is a physical machine configured to execute logical operations based on or influenced by quantum-mechanical phenomena. Such logical operations may include, for example, mathematical computation. Current interest in quantum-computer technology is motivated by analysis suggesting that the computational efficiency of an appropriately configured quantum computer may surpass that of any practicable non-quantum computer when applied to certain types of problems. Such problems include computer modeling of natural and synthetic quantum systems, integer factorization, data searching, and function optimization as applied to systems of linear equations and machine learning.

Different types of quantum computers base their operation on different quantum-mechanical phenomena. A ‘topological’ quantum computer is a quantum computer whose operation is based on a non-Abelian topological phase of matter. This type of quantum computer is expected to be less prone to the issue of quantum decoherence than other types of quantum computers, and may therefore serve as a relatively fault-tolerant quantum-computing platform.

Majorana-based quantum computing is an approach to topological quantum computing that utilizes Majorana zero modes (MZMs). MZMs are instantiated at electrically floating superconducting regions of a quantum computing device. The parity of a pair of MZMs can be used to store information used in quantum computations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides, on a quantum computing device, a method of tuning a topological qubit device into a Majorana Parity Readout (MPR) configuration. The method comprises performing optimization of an MPR signal by iteratively adjusting one or more tuning parameters of a plurality of tuning parameters, the plurality of tuning parameters comprising a quantum dot (QD) detuning, an enclosed flux, a voltage of a topological wire, a QD-Majorana zero mode (MZM) coupling, and a QD-QD coupling. Performing optimization of the MPR signal further comprises iteratively measuring the MPR signal using a readout resonator. Optimization of the MPR signal is iteratively performed until reaching a success metric.

### BRIEF DESCRIPTION OF THE DRAWINGS

FIG. 1 shows aspects of an example quantum computer.

FIG. 2 illustrates a Bloch sphere, which graphically represents the quantum state of one qubit of a quantum computer.

FIG. 3 shows aspects of an example signal waveform for effecting a quantum-gate operation in a quantum computer.

FIG. 4 shows a schematic depiction of a Majorana-based topological qubit system.

FIG. 5 shows a portion of the qubit system of FIG. 4, and illustrates locations of example Majorana zero modes (MZMs) and quantum dots (QDs).

FIG. 6 shows example charge stability diagrams.

FIG. 7 shows a flow diagram depicting an example process for tuning a MZM-QD coupling.

FIG. 8 shows example data that is collected during the measurement for the MZM-QD coupling. The histograms depict the distribution of datapoints and can be used to determine and correct an offset of the C_{Q} and iC_{Q} data.

FIG. 9 schematically shows a preparation of a simulated data set by shifting and stitching together simulations of single peaks of quantum capacitance to reproduce the shape of the experimental data.

FIG. 10 shows an example heatmap illustrating a result of fitting experimental C_{Q} and simulated C_{Q} values.

FIG. 11 shows a visual comparison of the fitted simulated data to the experimental data.

FIG. 12 schematically shows an example computing system that can enact one or more of the methods and processes described above, according to the example of FIG. 1.

### DETAILED DESCRIPTION

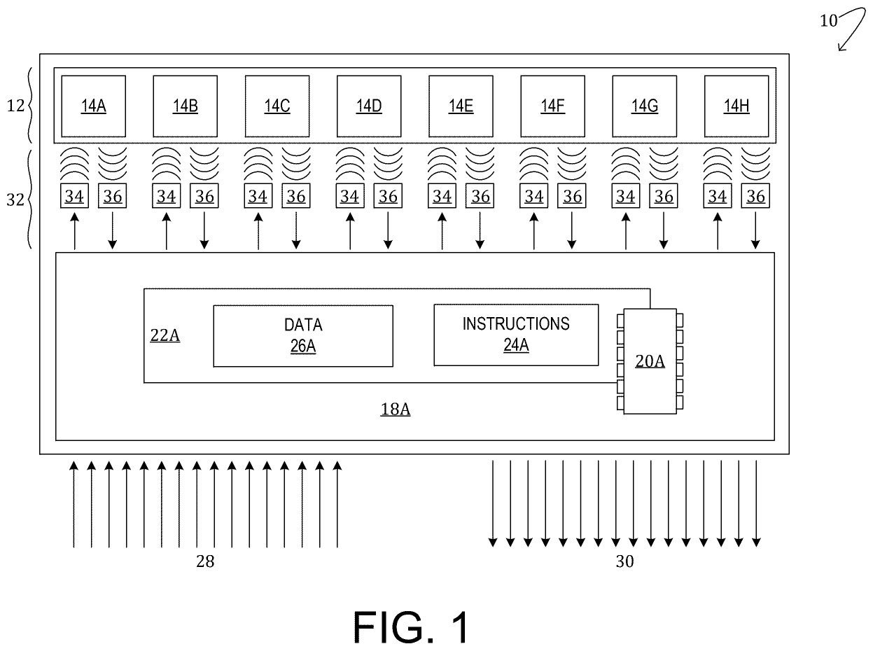

FIG. 1 schematically shows aspects of an example quantum computer 10 configured to execute quantum-logic operations. Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 10 of FIG. 1 includes at least one qubit register 12 comprising an array of qubits 14. The illustrated qubit register is eight qubits in length; qubit registers comprising longer and shorter qubit arrays are also envisaged, as are quantum computers comprising two or more qubit registers of any length. Qubits 14 of qubit register 12 take the form of Majorana zero mode (MZM)-based qubits, as described in more detail below.

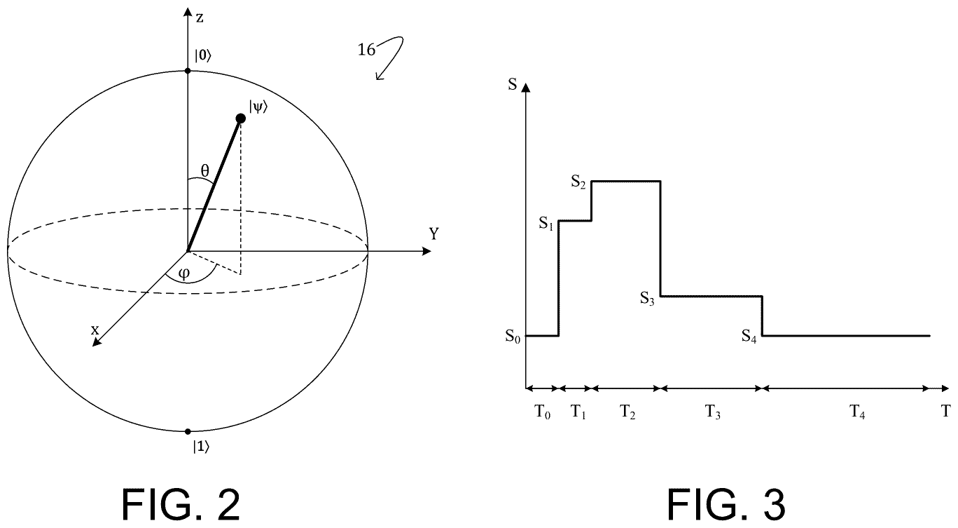

FIG. 2 is an illustration of a Bloch sphere 16, which provides a graphical description of some quantum mechanical aspects of an individual qubit 14. In this description, the north and south poles of the Bloch sphere correspond to the standard basis vectors |0 [symbol] and |1 [symbol] , respectively. The set of points on the surface of the Bloch sphere comprise all possible pure states |ψ [symbol] of the qubit, while the interior points correspond to all possible mixed states. A mixed state of a given qubit may result from decoherence, which may occur because of undesirable coupling to external degrees of freedom.

Returning again to FIG. 1, quantum computer 10 includes a controller 18A. The controller includes at least one processor 20A and associated computer memory 22A. A processor 20A of controller 18A may be coupled operatively to peripheral componentry, such as network componentry, to enable the quantum computer to be operated remotely. A processor 20A of controller 18A may take the form of a central processing unit (CPU), a graphics processing unit (GPU), or the like. As such, the controller may comprise classical electronic componentry. The terms ‘classical’ and ‘non-quantum’ are applied herein to any component that can be modeled accurately as an ensemble of particles without considering the quantum state of any individual particle. Classical electronic components include integrated transistors, resistors, and capacitors, for example. Computer memory 22A may be configured to hold program instructions 24A that cause processor 20A to execute any function or process of the controller. The computer memory may also be configured to hold additional data 26A. In examples in which qubit register 12 is a low-temperature or cryogenic device, controller 18A may include control componentry operable at low or cryogenic temperatures. In such examples, the low-temperature control componentry may be coupled operatively to interface componentry operable at normal temperatures.

Controller 18A of quantum computer 10 is configured to receive a plurality of inputs 28 and to provide a plurality of outputs 30. The inputs and outputs may each comprise digital and/or analog lines. At least some of the inputs and outputs may be data lines through which data is provided to and/or extracted from the quantum computer. Other inputs may comprise control lines via which the operation of the quantum computer may be adjusted or otherwise controlled.

Controller 18A is operatively coupled to qubit register 12 via quantum interface 32. The quantum interface is configured to exchange data bidirectionally with the controller. The quantum interface is further configured to exchange signal corresponding to the data bidirectionally with the qubit register. Depending on the architecture of quantum computer 10, such signal may include electrical, magnetic, and/or optical signal. Via signal conveyed through the quantum interface, the controller may interrogate and otherwise influence the quantum state held in the qubit register, as defined by the collective quantum state of the array of qubits 14. To this end, the quantum interface includes at least one modulator 34 and at least one demodulator 36, each coupled operatively to one or more qubits of the qubit register. Each modulator is configured to output a signal to the qubit register based on modulation data received from the controller. Each demodulator is configured to sense a signal from the qubit register and to output data to the controller based on the signal. The data received from the demodulator may, in some examples, be an estimate of an observable to the measurement of the quantum state held in the qubit register.

In some examples, suitably configured signal from modulator 34 may interact physically with one or more qubits 14 of qubit register 12 to trigger measurement of the quantum state held in one or more qubits. Example methods of interacting with MZM-based qubits are described in more detail below. Demodulator 36 may then sense a resulting signal released by the one or more qubits pursuant to the measurement, and may furnish the data corresponding to the resulting signal to controller 18A. Stated another way, the demodulator may be configured to output, based on the signal received, an estimate of one or more observables reflecting the quantum state of one or more qubits of the qubit register, and to furnish the estimate to the controller.

Pursuant to appropriate input from controller 18A, quantum interface 32 may be configured to implement one or more quantum-logic gates to operate on the quantum state held in qubit register 12. Whereas the function of each type of logic gate of a classical computer system is described according to a corresponding truth table, the function of each type of quantum gate is described by a corresponding operator matrix. The operator matrix operates on (i.e., multiplies) the complex vector representing the qubit register state and effects a specified rotation of that vector in Hilbert space.

For example, the Hadamard gate HAD is defined by

$$HAD = \frac{1}{\sqrt{2}} [ \begin{matrix}1 & 1 \\ 1 & - 1\end{matrix} ] . \qquad ( 1 )$$

The HAD gate acts on a single qubit; it maps the basis state |0 [symbol] to (|0 [symbol] +|1 [symbol] )/\sqrt{2}, and maps |1 [symbol] to (|0 [symbol] −|1 [symbol] )/\sqrt{2}. Accordingly, the HAD gate creates a superposition of states that, when measured, have equal probability of revealing |0 [symbol] or |1 [symbol] .

The phase gate S is defined by

$$S = [ \begin{matrix}1 & 0 \\ 0 & {e}^{i π / 2}\end{matrix} ] . \qquad ( 2 )$$

The S gate leaves the basis state |0 [symbol] unchanged but maps |1 [symbol] to e^{iπ/2}|1 [symbol] . Accordingly, the probability of measuring either |0 [symbol] or |1 [symbol] is unchanged by this gate, but the phase of the quantum state of the qubit is shifted. This is equivalent to rotating ψ by 90 degrees along a circle of latitude on the Bloch sphere of FIG. 2.

Some quantum gates operate on two or more qubits. The SWAP gate, for example, acts on two distinct qubits and swaps their values. This gate is defined by

$$SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] . \qquad ( 3 )$$

The foregoing list of quantum gates and associated operator matrices is non-exhaustive, but is provided for ease of illustration. Other quantum gates include Pauli-X, -Y, and -Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

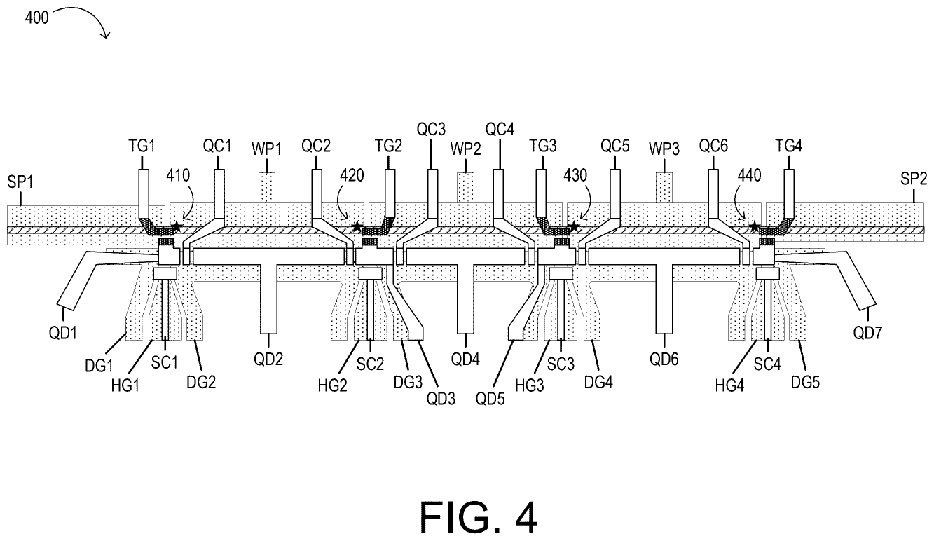

Continuing in FIG. 1, suitably configured signal from modulators 34 of quantum interface 32 may interact physically with one or more qubits 14 of qubit register 12 so as to assert any desired quantum-gate operation. As noted above, the desired quantum-gate operations are specifically defined rotations of a complex vector representing the qubit register state. In order to effect a desired rotation O, one or more modulators of quantum interface 32 may apply a predetermined signal level Sᵢ for a predetermined duration Tᵢ. In some examples, plural signal levels may be applied for plural sequenced or otherwise associated durations, as shown in FIG. 3, to assert a quantum-gate operation on one or more qubits of the qubit register. In general, each signal level Sᵢ and each duration Tᵢ is a control parameter adjustable by appropriate programming of controller 18A.

In a topological quantum computer, the quantum state held in each qubit is a state of two or more braidable quasiparticles, or ‘anyons’, observed within a non-Abelian topological phase of matter. Majorana-based qubit systems use a semiconductor-superconductor heterostructure wherein superconductivity, strong spin-orbit coupling, and magnetic fields cooperate to form a topological, superconducting state that supports Majorana zero modes (MZMs). This architecture employs a ‘measurement-based’ method wherein a sequence of measurements has the same effect as a braiding operation. This architecture does not require quasiparticles to be moved, but rather exploits a distinction between a ‘fermion parity-protected topological phase’ (the actual genus of the proposed heterostructure) and a true topological phase. Advantageously, topological charge in a fermion parity-protected topological phase can be manipulated by the process of electron tunneling into a MZM. Transport through a pair of MZMs can provide a measurement of their combined topological charge in the presence of a large charging energy.

In view of these and other useful properties, MZMs may be used as a basis for the qubits of a topological quantum computer. The MZMs are created at the ends of semiconductor-superconductor heterostructures tuned into a topological regime by the appropriate magnetic field and gate voltages. A series of practical implementations are described in T. Karzig, C. Knapp, R. M. Lutchyn, P. Bonderson, M. B. Hastings, C. Nayak, J. Alicea, K. Flensberg, S. Plugge, Y. Oreg, et al., Scalable designs for quasiparticle-poisoning-protected topological quantum computation with Majorana zero modes, Physical Review B 95, 235305 (2017). Examples of suitable heterostructure materials and material properties are described in Lutchyn et al., Majorana Fermions and a Topological Phase Transition in Semiconductor-Superconductor Heterostructures, arXiv: 1002.4033v2 [cond-mat.supr-con] 13 Aug. 2010. The entirety of both of the above references is hereby incorporated by reference herein for all purposes.

### Tuning Protocol

### I. Motivation

The remainder of this detailed description discusses a protocol to tune a topological qubit device into the Majorana Parity Readout (MPR) configuration. In some topological computing devices, the parity of a pair of Majorana zero modes (MZMs) can be probed by selectively coupling the MZMs to an array of quantum dots (QDs). The device includes a microwave resonator as a readout resonator, where at least one of the quantum dots is capacitively coupled to the readout resonator. This configuration allows the state of the system to be probed by detecting a frequency shift of the readout resonator. Such a configuration is fundamental for measurement-based quantum computation with Majorana zero modes. In a qubit, in general there will be several MPR loops, and an optimal tuning configuration needs to be identified for each one. The details of the readout scheme, briefly discussed below, are described in several publications and previous disclosures, including Karzig et al., cited above.

### II. Overview

The goal of the MPR measurement is to detect the joint parity of two or more MZMs through the change in the quantum capacitance (C_{Q}) of a quantum dot that is coupled to the Majorana modes in such a way as to form an interferometer with enclosed flux Φ. This flux can be tuned with an out-of-plane magnetic field. The quantum dot's quantum capacitance contributes to a larger resonant microwave circuit. If tuned successfully, the quantum capacitance C_{Q}(p, Φ) depends on both the parity of the Majorana modes p=±1 and the enclosed flux. The difference between the two parity states is referred to as ΔC_{Q}(Φ)=|C_{Q}(+, Φ)−C_{Q}(−, Φ). The dependence of ΔC_{Q} on Φ will be approximately periodic over some field range, with the periodicity given by the magnetic flux quantum Φ₀=h/(2e). The goal of the protocol is therefore to determine a tuning point for all the gates of the device as well as the magnetic field (in and out of plane) where ΔC_{Q} is maximal and can be attributed to the readout of the parity of Majorana zero modes.

In a realistic setting, the parity p is not preserved perfectly and will fluctuate on a timescale referred to as parity flip time (example origins of the fluctuations are quasiparticle poisoning and residual couplings to other low energy modes). At a given tuning point and fixed flux Φ, this will give rise to a telegraph-like time dependence of C_{Q}(t). This allows extraction of ΔC_{Q} at a given parameter point, e.g. by fitting a histogram of C_{Q}(t) to a sum of two Gaussians with separation ΔC_{Q} (and each Gaussian having a variance given by noise in the readout system). In addition to the quantum capacitance difference ΔC_{Q}, the parity-averaged quantum capacitance C_{Q} also can be defined. In general, C_{Q} will also be flux-dependent with the same flux periodicity as ΔC_{Q}; however, the amplitude of the flux oscillation is in general different to that of ΔC_{Q}.

### III. Example Tuning Protocol

At a high level, the steps of an example tuning protocol are as follows.
1. Quantum dot coarse tuning: In this step, the gates tuning the semiconducting part of the device are tuned such that an array of well-defined quantum dots are formed. For later operation of the device, it is advantageous to identify a regime with large charging energy EC and level spacing 8. This tuning is typically performed using electrical transport measurements, and follows standard procedures for semiconductor quantum devices.
2. Tuning of the topological segments: In this step, the superconducting segments of the device are tuned into the topological phase. This follows the Topological Gap Protocol (TGP) as described in D. I. Pikulin, B. van Heck, T. Karzig, E. A. Martinez, B. Nijholt, T. Laeven, G. W. Winkler, J. D. Watson, S. Heedt, M. Temurhan, et al., Protocol to identify a topological superconducting phase in a three-terminal device, arXiv preprint arXiv: 2103.12217 (2021); and M. Aghaee, A. Akkala, Z. Alam, R. Ali, A. A. Ramirez, M. Andrzejczuk, A. E. Antipov, P. Aseev, M. Astafev, B. Bauer, et al., InAs-Al hybrid devices passing the topological gap protocol, Physical Review B 107, 245423 (2023), the entire disclosures of which are incorporated by reference in their entireties for all purposes.
3. Quantum dot fine tuning: Due to cross-capacitance between the gates controlling the superconducting segments and the quantum dots, the QDs may need to be retuned after running the TGP. At this point, the coupling between the quantum dots (QD-QD coupling) is tuned to a favorable regime, including identifying charge transitions on each dot that give rise to appreciable QD-QD coupling.
4. Tuning the coupling between quantum dots and Majorana zero modes: The coupling between the quantum dots and the Majorana zero modes, henceforth referred to as QD-MZM coupling, is one of the key metrics determining the achievable signal in MPR measurements. Therefore, tuning this to be maximal is an important part of the overall measurement flow. This step, which is partially done in transport and partially using rf measurements, is discussed in a separate section below.
5. Optimizing MPR signal: In the final step, while keeping all quantum dots within or near a chosen charge states and keeping the superconducting wire within the topological phase, the detuning of the quantum dots is chosen to optimize (e.g. maximize) the flux-dependent signal ΔC_{Q}. This can be done by measuring C_{Q} or ΔC_{Q} as function of the tuning parameters. Examples of tuning parameters include a QD detuning, an enclosed flux, a voltage of a topological wire, a QD-MZM coupling, and a QD-QD coupling. The tuning parameters are adjusted and the MPR signal is measured using a readout resonator in an iterative manner to optimize the MPR signal.

### IV. Detailed Tune-Up Procedure

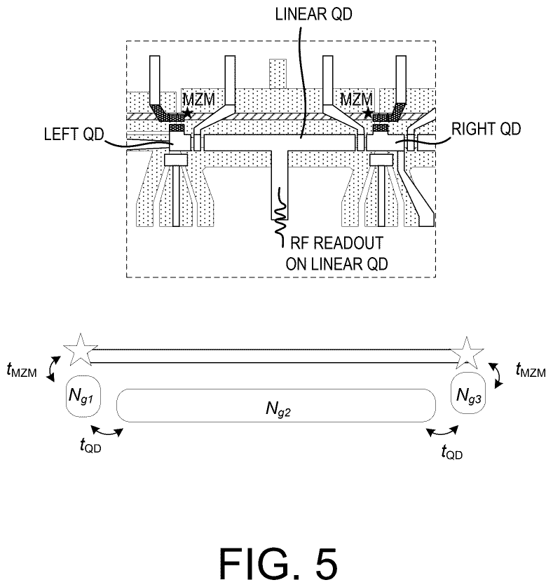

In the following section, as specific illustration of the protocol outlined above, the MPR tuning protocol is described as applied to the example device 400 of FIG. 4. However, a similar set of steps could be applied to other devices with different geometry but similar basic functionality, such as the different types of tetrons and hexons described in Karzig et al., cited above.

### A. Pre-TGP Wire Transport

First, the source terminals are isolated from one another by setting all depletion gates (DG1, DG2, DG3, DG4, DG5) below their depletion point and by setting QC1 and QC2 below their depletion point. In this configuration, the depletion voltage, induced gap, and parent gap of the topological wire segment are measured using local and non-local conductance spectroscopy as described in Aghaee et al., cited above.

### B. Dot Pre-Tuning

Next, rough tune-up of the quantum dots is done via DC transport at a magnetic field of 2.5 T parallel to the nanowire axis such that the orbital structure is roughly matched to the final state when the wire is tuned to the topological phase. The dots first are isolated from the wire by setting TG1 and TG2 to full depletion. Transport is measured from source 1 (transport channel under HG1 which is set to accumulation) to source 2 (transport channel under HG2 which is set to accumulation) with each dot formed by setting the adjacent cutter gates (i.e. SC or QC gate) to the tunneling regime and dot plungers to +0.5 V. The voltages on the cutter gates on either side of the dot are swept while measuring conductance at zero bias to identify the tunneling regime for each of the tunnel junctions. A map of Coulomb diamonds is used to verify successful tune-up of each QD. Once dot tune-up has been verified, the optimal resonator response is identified by measuring dispersive gate sensing (DGS) while sweeping RF frequency and dot plunger. This procedure is repeated for each of the three single dots. Finally, the conductance is measured while sweeping RF drive power and QD2 voltage to observe broadening of the Coulomb blockade peaks and extract the lever arm used to convert RF drive power to voltage reaching the device. The result of this step is the coarse operating regime of the gates QD1, QD2, QD3, QC1 and QC2 as well as the depletion points of SC1 and SC2.

Now, a fully isolated triple quantum dot (TQD) QD1-QD2-QD3 is formed by setting SC1 and SC2 below their depletion points while also leaving TG1 and TG2 below depletion. The dot plungers are left at the optimal value found in the previous step of single dot tune-up steps. First, a double quantum dot (DQD) is formed by setting QC2 to depletion. The RF response of QD2 is monitored while sweeping the voltages on QC1 and QD1. The interdot quantum capacitance will give rise to a measurable RF response in a narrow window of QC1 voltage. Below this range the RF response is suppressed as the tunnel coupling drops below the temperature. Above this range, the magnitude of the quantum capacitance is suppressed by the large anti-crossing (and subsequently small curvature) of the DQD ground state. Once this optimal range in QC1 is identified, QC1 is set to depletion and the same procedure is repeated for QC2. With the optimal ranges of the two QC gates identified, a TQD is formed in this isolated configuration by setting both QC gates to their optimal values. A TQD charge stability diagram is used to verify successful tune-up of the TQD. This procedure may also be done with the help of fitting the obtained data to simulations as this enables extracting the QD-QD couplings quantitatively and thus allows to choose a desired regime (which can also be informed by simulations).

### C. TGP

With the optimal voltages for the dots identified, the example detailed procedure can proceed to tuning the device into the topological phase. SC1 and SC2 are set back to accumulation while TG1 and TG2 are set to the tunneling regime to enable transport measurements on the wire again. The dot plungers are unchanged from the preceding step, and QC1 and QC2 are set below their depletion points to isolate the sources from one another. With SP1 and WP2 set negatively enough to fully deplete the wire underneath each gate, stages 1 and 2 of the TGP are run as described in Aghaee, cited above.

### D. QD-MZM Tuning/MPR Pre-Tuning

The focus is next on the putative topological phase, a region in magnetic field B and WP1 voltage (which controls the density in the wire) where there are stable zero-bias peaks (ZBPs) at both ends and a transport gap in the bulk of the wire. After completion of a successful TGP stage 2, a magnetic field with both sizeable transport gap and extent in WP1 voltage is selected for subsequent measurements. With this field selected and WP1 set inside the ROI, TG1 and TG2 are varied to achieve a ZBP conductance >e²/h at both ends of the wire. Once this coupling is established, SC1 and SC2 are set to depletion and all remaining measurements are done with DGS.

In order to establish a loop configuration, QC1 and QC2 are set back to their optimal values found in the earlier TQD tuning step. In order to balance the arms of the interferometer, the coupling of QD2 to each of MZM 410 and MZM 420 (QD-MZM coupling) is measured. In order to measure the QD-MZM coupling via the left arm of the interferometer, a scan of QD1 and QD2 is performed while recording the DGS response of the resonators connected to each of the dots. QD3 is tuned to blockade during this measurement. The QD-MZM couplings are determined from a fit to the data. QD2 similarly can be coupled to the other end of the wire through QD3 (with QD1 decoupled) to obtain the coupling of QD2 to MZM 420. Once the appropriate voltages on QD1 and QD3 have been selected, interferometer measurements to probe MZM pair parity can proceed.

### E. MPR

Finally, the capacitive response ΔC_{Q} and/or its noise ΔC_{Q} (or higher cumulants) is observed as a function of a small (a few mT) out of plane magnetic field. The expected signal is periodic with respect to the flux enclosed in the interference loop defined by the path QD1-QD2-QD3-MZM 420-MZM 410-QD1. The visibility of periodic oscillations (in C_{Q} and/or ΔC_{Q}) can be used to fine tune the various gates mentioned above. In particular it is useful to fine tune QD1 and QD3 as small changes in these gates can slightly detune the outside QDs which allows to improve the balancing of the arms of the interferometer. Moreover, it is useful to sweep QD2 and look for the charge state in QD2 with the best visibility of the interference signal.

The process described here may be used on any loop in a qubit device that includes Majorana zero modes that can be coupled to QDs for readout. Specific examples of loops in FIG. 4 are the loops defined by the path QD3-QD4-QD5-MZM 430-MZM 420-QD3; QD5-QD6-QD7-MZM 440-MZM 430-QD5.

The procedure may also be generalized to include a different number of QDs. The step of the protocol of coarse tuning of individual QDs can be performed with any number of QDs. The step of the fine tuning of coupled QDs may be performed by pairwise tuning of each adjacent QD pair. With this generalization one may for example tune up the interference loop defined by QD1-QD2-QD3-QD4-QD5-MZM 430-MZM 410-QD1 or similar loops in this device as well as different qubit device as outlined in T. Karzig, C. Knapp, R. M. Lutchyn, P. Bonderson, M. B. Hastings, C. Nayak, J. Alicea, K. Flensberg, S. Plugge, Y. Oreg, et al. Scalable designs for quasiparticle-poisoning-protected topological quantum computation with majorana zero modes, Physical Review B 95, 235305 (2017).

In a topological quantum computing platform all qubit measurements will include loops like the ones described above. The above procedure can then be used to tune up all the relevant loops for qubit measurements in the quantum computing platform.

As described above, optimization of the MPR signal comprises adjusting one or more tuning parameters, such as a QD detuning, an enclosed flux, a voltage of a topological wire, a QD-MZM coupling, or a QD-QD coupling. Optimization of the MPR signal further comprises measuring the MPR signal as a function of the tuning parameters using a readout resonator. The adjusting tuning parameters and measuring the MPR signal can be performed in an iterative manner until a success metric is achieved. For example, a success metric can comprise reaching a threshold value of Co and/or ΔC_{Q}. In some examples, the success metric comprises reaching a threshold value in the difference between parity states (ΔC_{Q}(Φ)=|C_{Q}(+, Φ)−C_{Q}(−, Φ)). In some examples, optimizing the MPR signal comprises maximizing the difference between parity states. In some more specific examples, optimizing the MPR signal comprises selecting a quantum dot detuning to maximize a difference between parity states.

### V. Detailed Example of QD-MZM Coupling Tuning

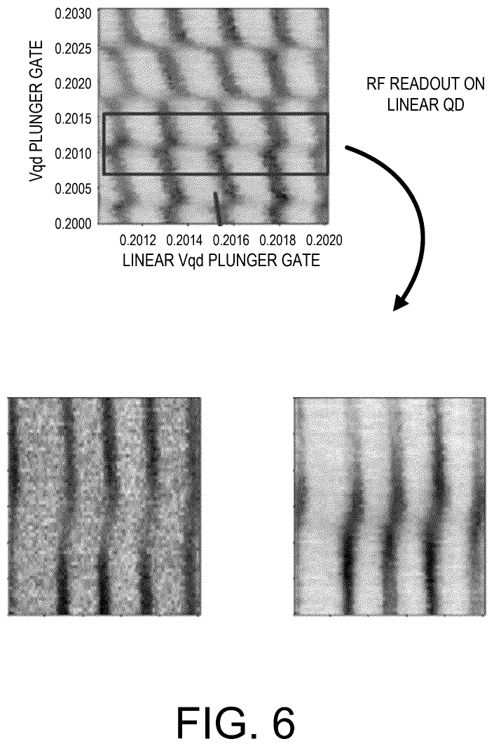

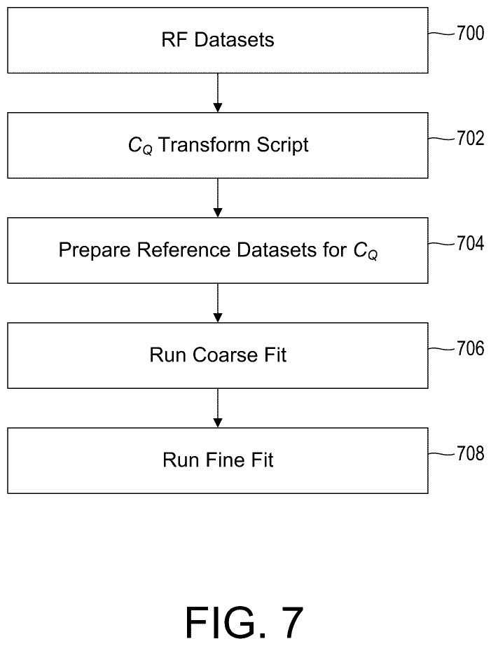

As described above, quantum dots (QDs) are used to interact with the MZMs and the readout can be performed with RF resonator chain coupled to each individual dot. FIG. 5 schematically illustrates a portion of the qubit system of FIG. 4, and illustrates locations of a pair of MZMs and three QDs. A readout resonator (not shown in FIG. 5) is coupled to the linear QD (“LINEAR QD” of FIG. 5). The readout resonator is used to assess the couplings to the MZMs, by detuning successively each of the side dots (“LEFT QD” and “RIGHT QD” of FIG. 5), then readout the voltage of triple points in a charge stability diagram, as shown in FIG. 6. These QDs are a part of the topological qubit design, with the readout performed in the same way in the large-scale quantum computer of the future. The tuning procedure described presently allows for finding optimal tuning of the quantum dots for best signal-to-noise ratio of the qubit readout. While the example depicted in FIG. 5 shows a linear QD, in other examples, any other suitable shape can be used for a QD, such as a curved or irregular shape, or LEFT/RIGHT QD as shown in the example design.

Open system dynamics simulations can reproduce to a high degree the behavior of quantum dots coupled to Majorana zero modes and interacting with a bath, such as quantum charge noise, and with the readout resonator. Running an instance of the simulation for a fixed set of parameters is computationally too expensive to be used within the cost function for general optimization methods to fit the experimental signal. Therefore, a dataset is produced encompassing all reasonable parameter choices. This dataset can be used as guidance to compare to the experimental signal and extract the best parameters, either by manual inspection or automated fitting. Without an automated tuning assistant, the process is time-consuming from the hardware bring-up point of view and can become an obstacle to scaling. Additionally, it is prone to operator's biases, which hampers the best possible tuning.

Thus, the experimental signal can be reconstructed based on the simulation dataset to allow efficient exploration of the parameter space to produce plausible parameter sets, therefore informing the experimental device to select different cutter voltages and to be able to reach high couplings of QD to MZM.

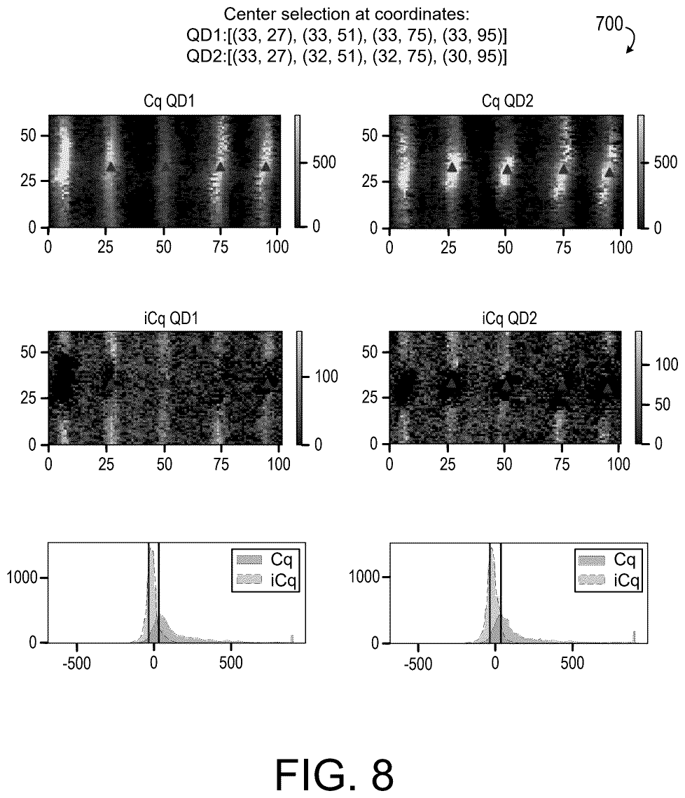

Referring next to FIG. 7, and as mentioned above, to tune the coupling of the QDs and MZMs, the response from the RF resonator (700 in FIG. 7) can be taken and converted to quantum capacitance (C_{Q}) units (702 in FIG. 7), by comparing it with a calibration curve of the resonator. This results in measured complex arrays, whose real part is the proper quantum capacitance, and the imaginary part corresponds to loss.

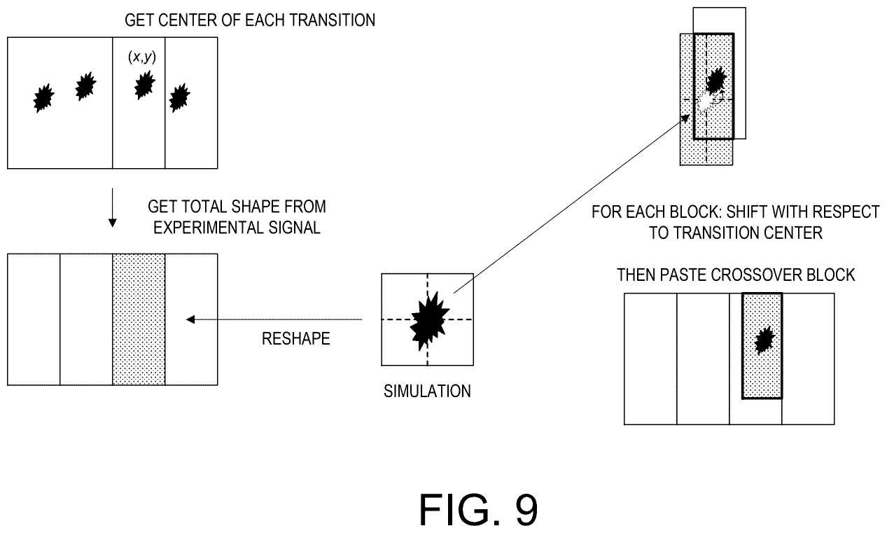

The conversion process from the RF response to a quantum capacitance may be imperfect and introduce artifacts by virtue of the noise present in the signal as well as imperfection of the conversion method. The C_{Q}-converted data can be post-processed to remove or reduce such artifacts. Such a post-processing step may include removing arrays of entries from the dataset used in the fitting step, or adjusting the offset of the experimental signal. In some examples, the post-processing step can comprise considering array entries within a selected range of values of quantum capacitance, and removing array entries outside the selected range. The histograms at the bottom row of FIG. 8 count the values of the C_{Q}-converted data. The value at the peak of the histograms is used as an origin to determine non-negativity. The results are shown in the upper rows, for each quantum dot. An image analysis algorithm tracks and suggests the points where the peaks of each transition are found. The suggested points can be adjusted, if necessary, before continuing.

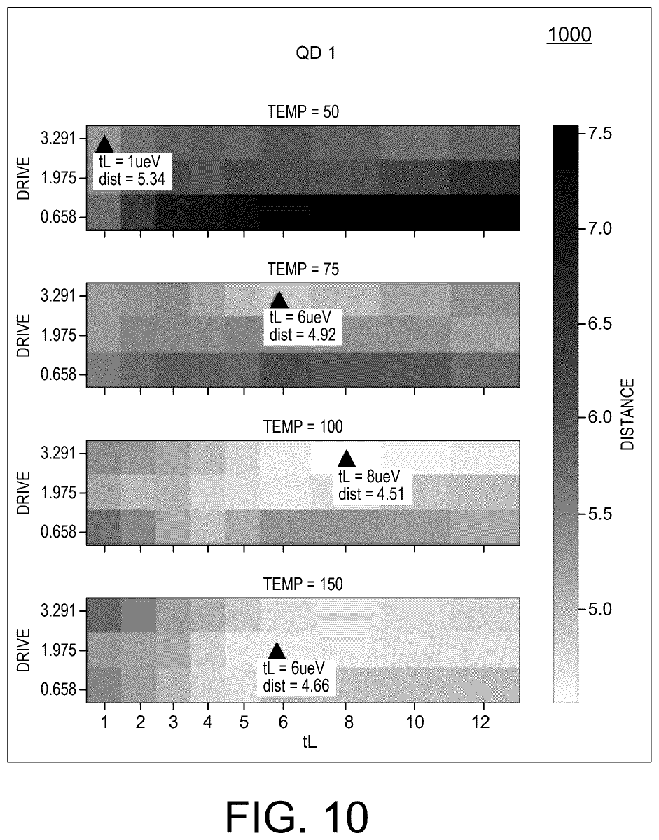

The next step is to prepare the reference datasets (704 in FIG. 7). Reference datasets can comprise, e.g., datasets formed from empirical data, or simulated datasets. In some examples, the simulated datasets comprise simulations of single peaks in C_{Q} and iC_{Q} that are stitched into an image of similar or the same shape as the measured C_{Q}-converted array. By using the centers found in the step above, the simulated map is shifted from the center of each one of 4 partitions of the available space (see FIG. 9). In other examples, the simulated dataset can comprise a different number of peaks. Then the remaining parts are filled with zeros and the same cutoff as above is enforced for non-negative values, in case they are also present in the simulated data.

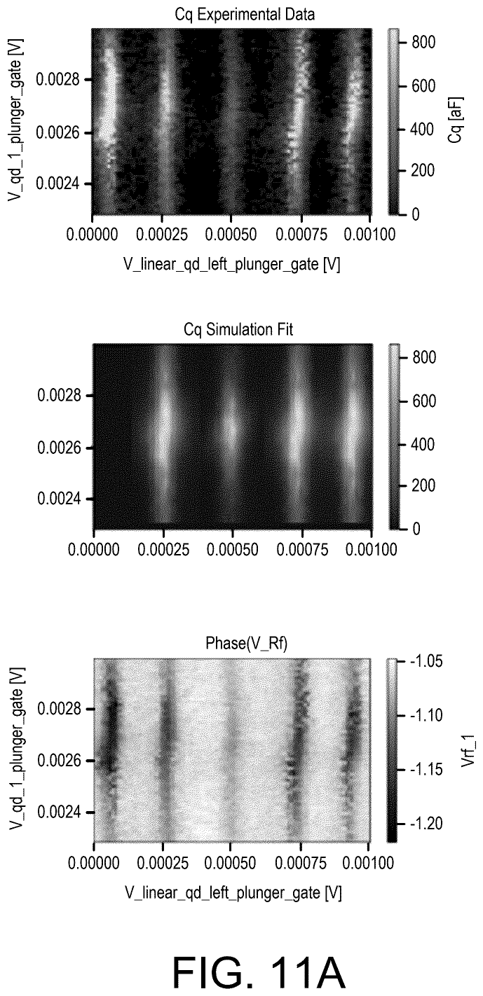

With both simulated and measured arrays, the arrays are compared (706 in FIG. 7) with an Lp-norm over the valid entries. Such a comparison can be performed over the entire array, or on a selected portion of the array (e.g., a bottom half of each array). This distance is recorded for every combination of parameters in the simulated datasets. This search can be performed more efficiently by selecting the most sensitive parameters with respect to the distance measure and then fitting one by one the parameters that modify independently each peak. The search can be sped up by using a suitable parallelization routine. The resulting scores are displayed in heatmaps such as that of FIG. 10. In other examples, any other suitable measure of distance can be used.

In FIG. 10, the brightest blocks correspond to the lowest distances between arrays, and a lowest peak is shown together with the resulting coupling of the corresponding quantum dot and the Majorana zero mode of that side. Note that if necessary, one can calculate the Lp-norm over the Fast Fourier Transform of the 2D array and select a proper filter, as well as using other preprocessing (e.g. compression, learning, etc.) techniques.

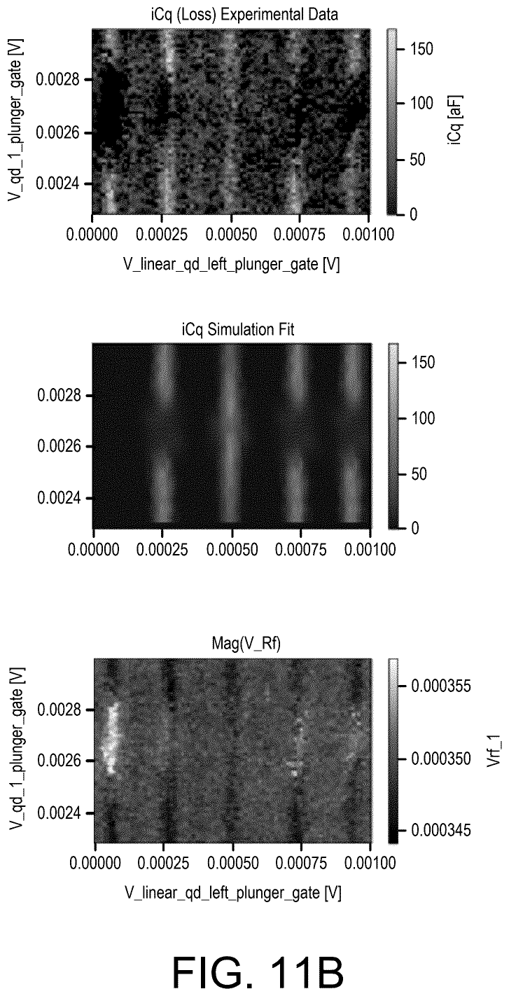

Within the bright regions of the heatmap, a fine scan is performed (708 of FIG. 7) that allows for visual verification of the suggested values for the couplings (see e.g. FIG. 11). This step is optional for the execution of the algorithm, but can be used to decide between different plausible fits.

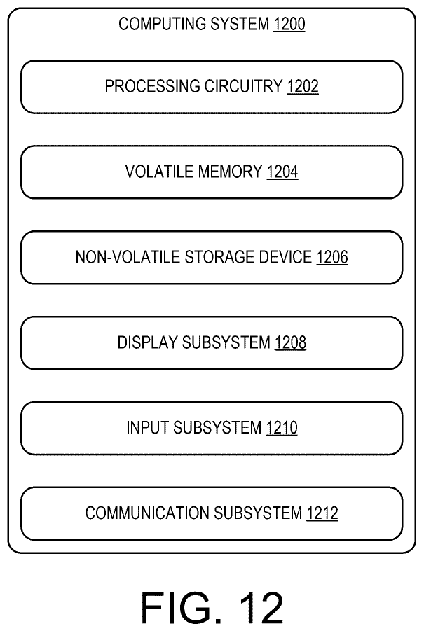

FIG. 12 schematically shows a non-limiting embodiment of a computing system 1200 that can enact one or more of the methods and processes described above. Computing system 1200 is shown in simplified form. Controller 18A, described above and illustrated in FIG. 1, is an example of computing system 1200. Components of computing system 1200 can be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 1200 includes processing circuitry 1202, volatile memory 1204, and a non-volatile storage device 1206. Computing system 1200 may optionally include a display subsystem 1208, input subsystem 1210, communication subsystem 1212, and/or other components not shown in FIG. 12.

Processing circuitry 1202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 1202 may be single-core or multi-core, and the instructions executed thereon may be configured for sequential, parallel, and/or distributed processing. Individual components of the processing circuitry 1202 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 1202.

Non-volatile storage device 1206 includes one or more physical devices configured to hold instructions executable by the processing circuitry to implement the methods and processes described herein. When such methods and processes are implemented, the state of non-volatile storage device 1206 may be transformed—e.g., to hold different data.

Non-volatile storage device 1206 may include physical devices that are removable and/or built in. Non-volatile storage device 1206 may include optical memory, semiconductor memory, and/or magnetic memory, or other mass storage device technology. Non-volatile storage device 1206 may include nonvolatile, dynamic, static, read/write, read-only, sequential-access, location-addressable, file-addressable, and/or content-addressable devices. It will be appreciated that non-volatile storage device 1206 is configured to hold instructions even when power is cut to the non-volatile storage device 1206.

Volatile memory 1204 may include physical devices that include random access memory. Volatile memory 1204 is typically utilized by processing circuitry 1202 to temporarily store information during processing of software instructions. It will be appreciated that volatile memory 1204 typically does not continue to store instructions when power is cut to the volatile memory 1204.

Aspects of processing circuitry 1202, volatile memory 1204, and non-volatile storage device 1206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via processing circuitry 1202 executing instructions held by non-volatile storage device 1206, using portions of volatile memory 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1208 may be used to present a visual representation of data held by non-volatile storage device 1206. The visual representation may take the form of a graphical user interface (GUI). As the herein described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with processing circuitry 1202, volatile memory 1204, and/or non-volatile storage device 1206 in a shared enclosure, or such display devices may be peripheral display devices.

When included, input subsystem 1210 may comprise or interface with one or more user-input devices such as a keyboard, mouse, touch screen, camera, or microphone.

When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 1200 to send and/or receive messages to and/or from other devices via a network such as the Internet.

Another example provides, on a quantum computing device, a method of tuning a topological qubit device into a Majorana Parity Readout (MPR) configuration. The method comprises performing optimization of an MPR signal by iteratively adjusting one or more tuning parameters of a plurality of tuning parameters, the plurality of tuning parameters comprising a quantum dot (QD) detuning, an enclosed flux, a voltage of a topological wire, a QD-Majorana zero mode (MZM) coupling, and a QD-QD coupling, and measuring the MPR signal using a readout resonator, until reaching a success metric. In some such examples, the method further comprises, prior to performing optimization of the MPR signal, tuning coupling between quantum dots and MZMs. Additionally or alternatively, in some such examples, tuning coupling between quantum dots and MZMs comprises measuring a coupling between quantum dots and the MZMs by dispersive gate sensing. Additionally or alternatively, in some such examples, the method further comprises, prior to tuning coupling between quantum dots and MZMs, performing quantum dot coarse tuning, tuning topological segments of a superconducting part of the topological qubit device into a topological phase, and performing quantum dot fine tuning. Additionally or alternatively, in some such examples, performing quantum dot fine tuning comprises pairwise tuning adjacent quantum dot pairs of a set of two or more quantum dots. Additionally or alternatively, in some such examples, performing quantum dot fine tuning comprises tuning coupling between quantum dots by identifying charge transitions on each quantum dot associated with the coupling between quantum dots. Additionally or alternatively, in some such examples, optimizing the MPR signal comprises selecting a quantum dot detuning to maximize a difference between parity states (ΔC_{Q}(Φ)=|C_{Q}(+, Φ)−C_{Q}(−, Φ)|). Additionally or alternatively, in some such examples, the method is performed on an interference loop comprising two or more quantum dots and two MZMs. Additionally or alternatively, in some such examples, the method further comprises using a readout resonator capacitively coupled to a quantum dot to probe a parity of MZMs of the quantum computing device. Additionally or alternatively, in some such examples, the success metric comprises one or more of reaching a threshold value of C_{Q} or reaching a threshold value of ΔC_{Q}.

Another example provides a quantum computing device comprising a topological qubit device and a controller. The topological qubit device comprises a semiconducting part comprising a set of quantum dots, and a superconducting part comprising a plurality of topological segments configured to instantiate one or more pairs of Majorana zero modes (MZMs). The controller is configured to adjust one or more tuning parameters of a plurality of tuning parameters, the plurality of tuning parameters comprising a quantum dot (QD) detuning, an enclosed flux, a voltage of a topological wire, a QD-MZM coupling, and a QD-QD coupling, and perform optimization of a Majorana Parity Readout (MPR) signal by iteratively adjusting the one or more tuning parameters, and measuring the MPR signal, until reaching a success metric. In some such examples, the controller is configured to tune coupling between quantum dots and MZMs by using dispersive gate sensing to measure a coupling between quantum dots and the MZMs. Additionally or alternatively, in some such examples, the controller is configured to optimize the MPR signal comprises by selecting a quantum dot detuning to maximize a difference between parity states (ΔC_{Q}(Φ)=|C_{Q}(+, Φ)−C_{Q}(−, Φ)|), and wherein the success metric comprises one or more of reaching a threshold value of C_{Q} or reaching a threshold value of ΔC_{Q}. Additionally or alternatively, in some such examples, the topological qubit device comprises an interference loop comprising two or more quantum dots and two MZMs, and the controller is configured to tune coupling between the two or more quantum dots and the two MZMs of the interference loop. Additionally or alternatively, in some such examples, the quantum computing device further comprises a readout resonator capacitively coupled to a quantum dot of the interference loop, and wherein the controller is configured to use the readout resonator to probe a parity of the two MZMs of the interference loop.

Another example provides a quantum computing device, comprising a topological qubit device, and a controller. The topological qubit device comprises a superconducting part comprising a plurality of topological segments configured to instantiate one or more pairs of Majorana zero modes (MZMs), a semiconducting part comprising a set of quantum dots, and a readout resonator coupled to a quantum dot of the set of quantum dots. The controller is configured to control the quantum computing device to perform quantum dot coarse tuning by tuning gates of the semiconducting part of the topological qubit device, tune topological segments of the superconducting part of the topological qubit device into a topological phase, perform quantum dot fine tuning, and tune coupling between quantum dots and MZMs. The controller is further configured to perform optimization of a Majorana Parity Readout (MPR) signal by iteratively adjusting one or more tuning parameters of a plurality of tuning parameters, the plurality of tuning parameters comprising a quantum dot (QD) detuning, an enclosed flux, a voltage of a topological wire, a QD-MZM coupling, and a QD-QD coupling, and measuring the MPR signal using the readout resonator, until reaching a success metric. In some such examples, the controller is configured to control the quantum computing device to perform quantum dot fine tuning by tuning coupling between quantum dots by identifying charge transitions on each quantum dot associated with the coupling between quantum dots. Additionally or alternatively, in some such examples, the controller is configured to control the quantum computing device to perform quantum dot fine tuning by pairwise tuning adjacent quantum dot pairs of a set of two or more quantum dots. Additionally or alternatively, in some such examples, the controller is configured to control the quantum computing device to tune coupling between quantum dots and MZMs by using dispersive gate sensing to measure a coupling between quantum dots and the MZMs. Additionally or alternatively, in some such examples, the controller is configured to control the quantum computing device to optimize the MPR signal comprises by selecting a quantum dot detuning, and reaching the success metric comprises reaching a threshold value of a difference between parity states (ΔC_{Q}(Φ)=|C_{Q}(+, Φ)−C_{Q}(−, Φ)|).

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. On a quantum computing device, a method of tuning a topological qubit device into a Majorana Parity Readout (MPR) configuration, the method comprising:
performing optimization of an MPR signal by iteratively
adjusting one or more tuning parameters of a plurality of tuning parameters, the plurality of tuning parameters comprising a quantum dot (QD) detuning, an enclosed flux, a voltage of a topological wire, a QD-Majorana zero mode (MZM) coupling, and a QD-QD coupling, and
measuring the MPR signal using a readout resonator,
until reaching a success metric.

2. The method of claim 1, further comprising, prior to performing optimization of the MPR signal, tuning coupling between quantum dots and MZMs.

3. The method of claim 2, wherein tuning coupling between quantum dots and MZMs comprises measuring a coupling between quantum dots and the MZMs by dispersive gate sensing.

4. The method of claim 2, further comprising, prior to tuning coupling between quantum dots and MZMs,
performing quantum dot coarse tuning,
tuning topological segments of a superconducting part of the topological qubit device into a topological phase, and
performing quantum dot fine tuning.

5. The method of claim 4, wherein performing quantum dot fine tuning comprises pairwise tuning adjacent quantum dot pairs of a set of two or more quantum dots.

6. The method of claim 4, wherein performing quantum dot fine tuning comprises tuning coupling between quantum dots by identifying charge transitions on each quantum dot associated with the coupling between quantum dots.

7. The method of claim 1, wherein optimizing the MPR signal comprises selecting a quantum dot detuning to maximize a difference between parity states (ΔC_{Q}(Φ)=|C_{Q}(+, Φ)−C_{Q}(−, Φ).

8. The method of claim 1, wherein the method is performed on an interference loop comprising two or more quantum dots and two MZMs.

9. The method of claim 1, further comprising using a readout resonator capacitively coupled to a quantum dot to probe a parity of MZMs of the quantum computing device.

10. The method of claim 1, wherein the success metric comprises one or more of reaching a threshold value of C_{Q} or reaching a threshold value of ΔC_{Q}.

11. A quantum computing device, comprising:
a topological qubit device, comprising
a semiconducting part comprising a set of quantum dots;
a superconducting part comprising a plurality of topological segments configured to instantiate one or more pairs of Majorana zero modes (MZMs); and
a controller configured to
adjust one or more tuning parameters of a plurality of tuning parameters, the plurality of tuning parameters comprising a quantum dot (QD) detuning, an enclosed flux, a voltage of a topological wire, a QD-MZM coupling, and a QD-QD coupling, and
perform optimization of a Majorana Parity Readout (MPR) signal by iteratively
adjusting the one or more tuning parameters, and
measuring the MPR signal,
until reaching a success metric.

12. The quantum computing device of claim 11, wherein the controller is configured to tune coupling between quantum dots and MZMs by using dispersive gate sensing to measure a coupling between quantum dots and the MZMs.

13. The quantum computing device of claim 11, wherein the controller is configured to optimize the MPR signal comprises by selecting a quantum dot detuning to maximize a difference between parity states (ΔC_{Q}(Φ)=|C_{Q}(+, Φ)−C_{Q}(−, Φ)|), and wherein the success metric comprises one or more of reaching a threshold value of C_{Q} or reaching a threshold value of ΔC_{Q}.

14. The quantum computing device of claim 11, wherein the topological qubit device comprises an interference loop comprising two or more quantum dots and two MZMs, and the controller is configured to tune coupling between the two or more quantum dots and the two MZMs of the interference loop.

15. The quantum computing device of claim 14, further comprising a readout resonator capacitively coupled to a quantum dot of the interference loop, and wherein the controller is configured to use the readout resonator to probe a parity of the two MZMs of the interference loop.

16. A quantum computing device, comprising:
a topological qubit device, comprising
a superconducting part comprising a plurality of topological segments configured to instantiate one or more pairs of Majorana zero modes (MZMs),
a semiconducting part comprising a set of quantum dots, and
a readout resonator coupled to a quantum dot of the set of quantum dots; and
a controller configured to control the quantum computing device to:
perform quantum dot coarse tuning by tuning gates of the semiconducting part of the topological qubit device,
tune topological segments of the superconducting part of the topological qubit device into a topological phase,
perform quantum dot fine tuning,
tune coupling between quantum dots and MZMs, and
perform optimization of a Majorana Parity Readout (MPR) signal by iteratively
adjusting one or more tuning parameters of a plurality of tuning parameters, the plurality of tuning parameters comprising a quantum dot (QD) detuning, an enclosed flux, a voltage of a topological wire, a QD-MZM coupling, and a QD-QD coupling, and
measuring the MPR signal using the readout resonator, until reaching a success metric.

17. The quantum computing device of claim 16, wherein the controller is configured to control the quantum computing device to perform quantum dot fine tuning by tuning coupling between quantum dots by identifying charge transitions on each quantum dot associated with the coupling between quantum dots.

18. The quantum computing device of claim 16, wherein the controller is configured to control the quantum computing device to perform quantum dot fine tuning by pairwise tuning adjacent quantum dot pairs of a set of two or more quantum dots.

19. The quantum computing device of claim 16, wherein the controller is configured to control the quantum computing device to tune coupling between quantum dots and MZMs by using dispersive gate sensing to measure a coupling between quantum dots and the MZMs.

20. The quantum computing device of claim 16, wherein the controller is configured to control the quantum computing device to optimize the MPR signal comprises by selecting a quantum dot detuning, and reaching the success metric comprises reaching a threshold value of a difference between parity states (ΔC_{Q}(Φ)=|C_{Q}(+, Φ)−C_{Q}(−, Φ)|).
